(19) United States
(12) Patent Application Publication
(10) Pub. No.: US 2011/0132200 A1
(43) Pub. Date: Jun. 9, 2011

(54) Liquid dispenser that stores and serves garnishes

(76) Inventor: Brad Pollack, E. Brunswick, NJ (US)

(21) Appl. No.: 12/592,980

(22) Filed: Dec. 8, 2009

(51) Int. Cl. A47J 31/20

(52) U.S. Cl. 99/319

(57) ABSTRACT

The Liquid Dispenser that Stores and Serves Garnishes represents a device which will store garnishes within the dispenser allowing the natural infusion between the liquid and the garnish. The liquid will become naturally flavored by the garnish, while the garnish becomes naturally flavored by the liquid. The device will utilize a tap comprising a valve and spout to regulate the delivery of the infused liquid. The screw on cap, which secures the liquid within the dispenser, will be attached to a plunger and permeable catch tray. The catch tray will hold the garnish without letting the garnish interfere with the tap. When the handle located on the screw on cap is pulled up, the garnish becomes available to be served. Serving the garnish is accomplished by two methods, the consumer can take the garnish from the catch tray, or the garnish will naturally fall onto the garnish serving tray.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Garnishes such as real fruit are commonly added to beverages to add flavor. Some beverages are artificially flavored to taste like a garnish or combination of garnishes. There are some liquid dispensers that provide the ability to add a garnish into the dispenser which will flavor the beverage being dispensed through a tap. The problem with existing types of liquid dispensers is the inability to serve the garnish. The only option would be to use a separate ladle to serve garnishes from the opening of an existing liquid dispenser. The Liquid Dispenser that Stores and Serves Garnishes creates the ability to naturally infuse any liquid with any garnish by being stored together in a bottle, while serving the naturally flavored liquor and the garnish separately in one device.

### BRIEF SUMMARY OF THE INVENTION

The Liquid Dispenser that Stores and Serves Garnishes represents a cylindrical liquid dispenser that can vary in the diameter and volume. The top of the cylinder is open and threaded to allow a screw on cap to secure the liquid in the dispenser similar to a bottle. The screw on cap has a plunger through the center of the cap extending downward into the dispenser. The plunger is designed with a handle at the top accessible on the exterior of the cap, and a permeable catch tray at the bottom of the plunger. The permeable catch tray will have a diameter that is ¼″ to ½″ less than the diameter of the cylindrical dispenser. The catch tray will store the garnish and by pulling up the handle of the plunger with the cap, the garnish will be accessible for serving. Since the catch tray is permeable, the liquid will remain in the dispenser when serving garnishes. A tap device will be connected to the dispenser that will enable the dispensing of the liquid.

### BRIEF DESCRIPTION OF THE SEVERAL VIEWS OF THE DRAWING

For a complete understanding of this invention, reference should be had to the following detailed description taken in connection with the accompanying drawings, in which:

FIG. 1 illustrates a side view of the liquid dispenser, a cylindrical bottle which comprises of a threaded and open top, along with a hole for connecting the tap. The threaded top 10 allows the screw on cap to securely close the opening of the bottle 12. A hole 14 is required along the side of the cylindrical bottle for the tap to be directly connected to the bottle. A hole 16 is required along the bottom of the cylindrical bottle when utilizing a separate base with a built in tap.

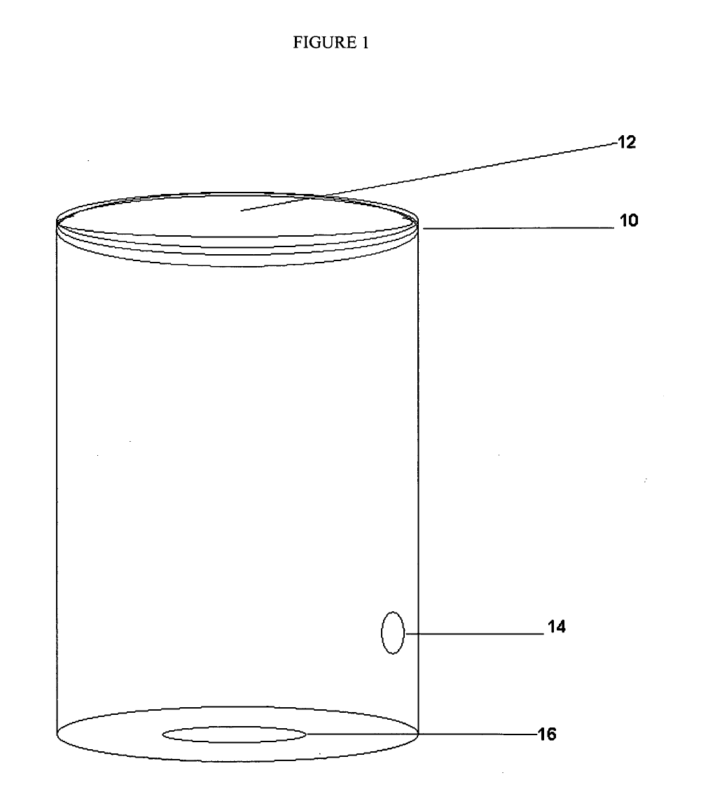

FIG. 2 illustrates a side view of the screw on cap with plunger and permeable catch tray. The screw on cap 20 has a hole in the center allowing the plunger 22 to pass through. The plunger which is threaded on both ends travel downward from the cap and is screwed into the permeable catch tray. The permeable catch tray 24 can have a lip 28 around the edge to reduce the ability for a garnish to pass below the catch tray. The other end of the plunger is screwed into a handle 26 that will secure the cap in place. This creates the ability to serve the garnish in one motion by pulling up the handle.

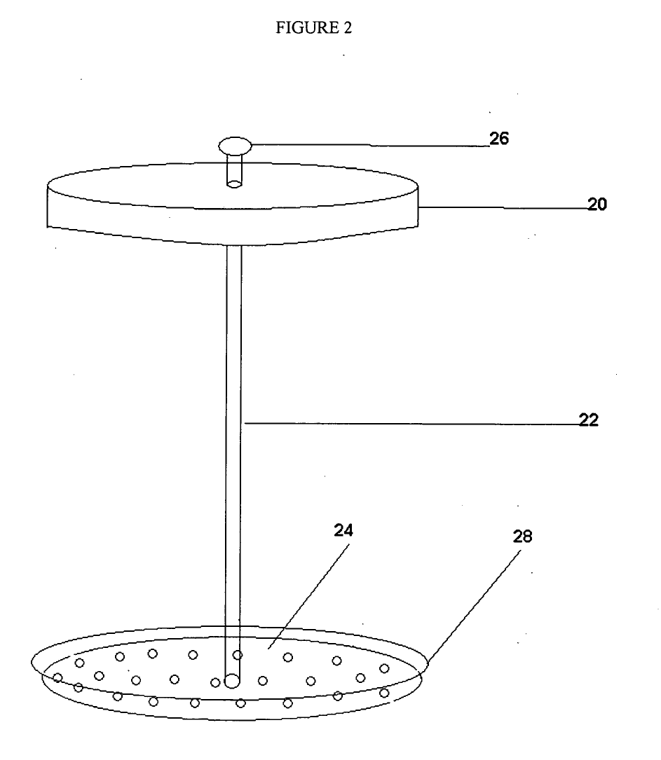

FIG. 3 illustrates a side view of the tap, for connection either directly into the cylindrical bottle or by using a separate base with built in tap. The tap consists of a valve 30 and a spout 32 which regulates the dispensing of the liquid. The separate base 38 will have a section 36 to hold the bottle in place, along with a piercing device 34 to break the seal located at the bottom of the cylindrical bottle.

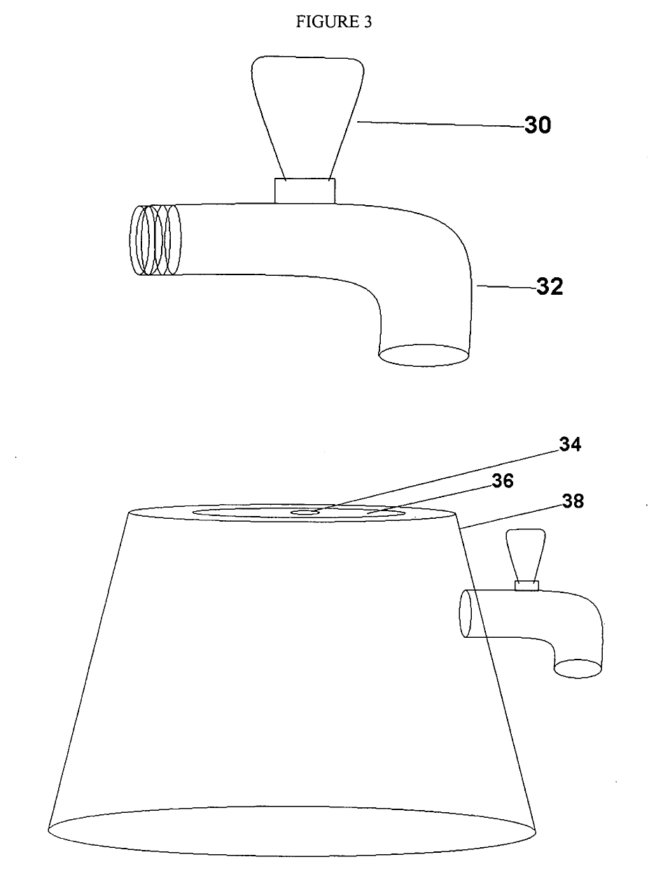

FIG. 4 illustrates a side view of the assembled Liquid Dispenser that Stores and Serves Garnishes. The garnish serving tray 40 will catch the garnishes when being served. The garnish can be served by pulling up the handle connected to the screw on cap. The garnish will naturally fall over the edge of the top of the cylindrical bottle and fall into the serving tray. The location of the tap which is directly connected to the cylindrical bottle is located towards the bottom of the bottle to allow gravity to assist in serving liquid through the tap. The size of the plunger allows the catch tray to rest above the tap so that the garnish will not interrupt the flow of liquid through the tap.

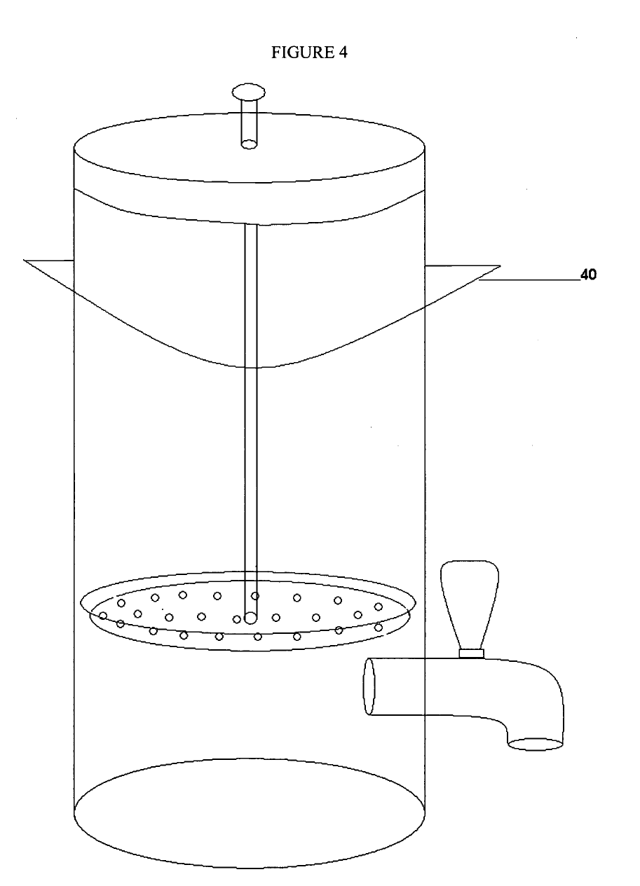

### DETAILED DESCRIPTION OF THE INVENTION

The Liquid Dispenser that Stores and Serves Garnishes is comprised of 3 main components, the dispenser, the cap with plunger, and the tap. When assembled, the invention will create a device that will infuse a liquid and garnish by storing both together, with the ability to dispense the liquid through the tap or serve the garnish using the cap with plunger and catch tray.

The main component of the Liquid Dispenser is the cylindrical bottle. This bottle is made of either glass or plastic. Dimensions of the bottle will vary based on desired volume capacity, determined by diameter of the base of the bottle and the height of the bottle. The bottom of the bottle may be rigid or include a rubber base cover to avoid sliding on a table top. The bottle will have an open and threaded top to be used in conjunction with a screw on cap to secure the liquid in the bottle. The bottle will have a hole allowing connection to the tap or base with tap. The exact location of this hole can vary, but the hole is located towards the base of the bottle.

The cap with plunger serves the purpose of securing the liquid within the bottle, storing and serving the garnish. The cap represents a threaded screw on cap with a small hole in the center of the cap to allow the plunger to pass through the cap. The plunger represents a rod that will travel from the cap down toward the base of the cylindrical bottle. The plunger will be threaded on both sides in order to screw into the catch tray and handle. The height of the plunger must be less than the height of the cylindrical bottle in order to store the garnish above the location of the tap. This will avoid any interference between the garnish and the tap. The top end of the plunger will be screwed into a handle device that will be located on the exterior of the cap. The bottom end of the plunger will be threaded and screwed into the permeable catch tray. When the plunger is screwed into the handle, the cap is secured to the plunger allowing the ability to access and serve the garnish in one motion.

The permeable catch tray will have a diameter that is between ¼ and ½ less than the diameter of the cylindrical bottle. The catch tray may or may not have a lip around the edge to reduce the ability for a garnish to pass below the catch tray. A catch tray must be permeable to allow the liquid to pass through while the garnishes are being served. This can be achieved by placing small holes through out the catch tray, or making a catch tray using mesh wiring. Multiple permeable catch trays can be used in order to accommodate storing all garnish types.

The tap represents a device comprising of a valve and spout that will regulate the dispensing of the liquid. The tap will be connected to the cylindrical bottle through a hole, with each bottle being designed to work with either a direct tap or separate base—not both. A tap can be connected directly to the bottle through a hole on the side of the bottle located towards the bottom half of the bottle. The force of gravity will create the flow of liquid through the tap when being served. A separate base with a built in tap can be used, and the bottle will have a hole located at the center of the base of the bottle in order to be connected to the separate base. The hole will be covered with a breakable plastic cover which is penetrated when the bottle is connected to the separate base. Once the plastic cover is penetrated the liquid will be accessible and delivered through the tap.

I claim:

1. For use in serving liquid infused by a garnish and the garnish separately, a Liquid Dispenser that Stores and Serves Garnishes comprising:
A cylindrical bottle
A screw on cap with plunger and permeable catch tray
A device for dispensing the liquid
Said cylindrical bottle represents the liquid dispenser which is made with glass or plastic, and may include a rigid bottom or rubber base to prevent sliding.
Said cylindrical bottle has an open and threaded top that allows for a screw on cap to secure the liquid in the dispenser.
Said cylindrical bottle will have a hole used to connect directly to the device, or to a separate base with a built in device for dispensing the liquid.
Said screw on cap with plunger consists of 4 components, (1) The threaded screw on cap with a hole for plunger to pass through. (2) A screw on handle connected to the plunger locking the screw on cap in place. (3) A plunger which represents a rod that connects the screw on cap with the permeable catch tray. The length of the rod must be less than the height of the cylindrical dispenser. (4) A permeable catch tray that has small holes to allow the liquid to pass through, and a lip to catch the garnish in the tray for serving purposes.
Said device for dispensing the liquid represents a tap device with a valve and spout used to regulate delivery of a liquid.
Said device for dispensing the liquid may be connected directly into the cylindrical bottle, or part of a separate base used in connection with the cylindrical bottle for the purpose of dispensing the garnish infused liquid.

2. A Liquid Dispenser that Stores and Serves Garnishes as set forth in claim 1 wherein the garnish will be stored within the dispenser to allow for an infusion process which will naturally flavor the liquid with the garnish, and naturally flavor the garnish with the liquid.

3. A Liquid Dispenser that Stores and Serves Garnishes as set forth in claim 1 wherein the invention has the ability to serve a liquid beverage and/or garnish separately without the use of any outside devices.
